(19) United States
(12) Patent Application Publication
(10) Pub. No.: US 2022/0189332 A1
(43) Pub. Date: Jun. 16, 2022

(54) AUGMENTING AN ANSWER SET

(71) Applicant: Mocha Technologies Inc., Claymont, DE (US)

(72) Inventors: Sujit Karpe, Pune (IN); VISHAL MADAN, Pune (IN); WOLFGANG HOLTGEN, LAATZEN (DE)

(21) Appl. No.: 17/123,558

(22) Filed: Dec. 16, 2020

(51) Int. Cl. G09B 7/02; G09B 7/10

(52) U.S. Cl. CPC G09B 7/02; G09B 7/10

(57) ABSTRACT

A method and a system for augmenting an answer set on an online platform is disclosed. The method includes receiving an answer to a question. The answer may be received from a plurality of candidates. The method further includes comparing the answer with a predefined answer. The method furthermore includes identifying a deviation between the answer and the predefined answer. The method furthermore includes counting a number of occurrences of the answer. The method furthermore includes alerting when the number of occurrences of the answer exceeds a predefined threshold. Finally, the method includes augmenting a predefined answer set by adding the answer post validating the answer.

### PRIORITY INFORMATION

The present application does not claim a priority from any other application.

### TECHNICAL FIELD

The present subject matter described herein, in general, relates to a method of evaluating an answer on an online assessment platform.

### BACKGROUND

In recent times, the use of online assessment platforms has increased drastically. Almost all the companies are conducting an online assessment test for talent acquisition (recruitment), talent management (learning and development) and certification program. Computer systems have been developed for the assessment of open-ended test answers such as essay, program codes, fill in the blanks, and language proficiency responses. It must be noted that an examiner has to spend a lot of time and effort in evaluating the open-ended test answers. It has been observed that there is still a need for an improved system for assessing the open-ended test answers without manual intervention.

### SUMMARY

Before the present system(s) and method(s), are described, it is to be understood that this application is not limited to the particular system(s), and methodologies described, as there can be multiple possible embodiments which are not expressly illustrated in the present disclosures. It is also to be understood that the terminology used in the description is for the purpose of describing the particular implementations or versions or embodiments only and is not intended to limit the scope of the present application. This summary is provided to introduce aspects related to a system and a method for augmenting an answer set on an online platform. This summary is not intended to identify essential features of the claimed subject matter nor is it intended for use in determining or limiting the scope of the claimed subject matter.

In one embodiment, a method for augmenting an answer set on an online platform is disclosed. Initially, an answer to a question may be received. The question may be at least one of a descriptive question, a program code, a fill in the blank question, a Multiple-Choice Question (MCQ), and a Multiple Answer Questions (MAQ). It may be noted that the answer may be received from a plurality of candidates. Subsequently, the answer may be compared with a predefined answer. The predefined answer set may be provided by at least an examiner or an online assessment platform. Further, a deviation between the answer and the predefined answer may be identified based upon the comparison. Furthermore, a number of occurrences of the answer may be counted. Subsequently, an alert may be generated when the number of occurrences of the answer exceeds a predefined threshold. Finally, a predefined answer set may be augmented by adding the answer post validating the answer. In one aspect, the aforementioned method for augmenting the answer set on the online platform may be performed by a processor using programmed instructions stored in a memory.

In another embodiment, a non-transitory computer-readable medium embodying a program executable in a computing device for augmenting an answer set on an online platform is disclosed. The program may comprise a program code for receiving an answer to a question. The question may be at least one of a descriptive question, a program code, a fill in the blank question, a Multiple-Choice Question (MCQ), and a Multiple Answer Questions (MAQ). It may be noted that the answer may be received from a plurality of candidates. Further, the program may comprise a program code for comparing the answer with a predefined answer. The predefined answer set may be provided by at least an examiner or an online assessment platform. Subsequently, the program may comprise a program code for identifying a deviation between the answer and the predefined answer based upon the comparison. Further, the program may comprise a program code for counting a number of occurrences of the answer. Furthermore, the program may comprise a program code for alerting when the number of occurrences of the answer exceeds a predefined threshold. Finally, the program may comprise a program code for augmenting a predefined answer set by adding the answer post validating the answer.

### BRIEF DESCRIPTION OF THE DRAWINGS

The foregoing detailed description of embodiments is better understood when read in conjunction with the appended drawings. For the purpose of illustrating of the present subject matter, an example of a construction of the present subject matter is provided as figures, however, the invention is not limited to the specific method and system for augmenting an answer set on an online platform disclosed in the document and the figures.

The present subject matter is described in detail with reference to the accompanying figures. In the figures, the left-most digit(s) of a reference number identifies the figure in which the reference number first appears. The same numbers are used throughout the drawings to refer to various features of the present subject matter.

FIG. 1 illustrates a network implementation for augmenting an answer set on an online platform, in accordance with an embodiment of the present subject matter.

FIG. 2 illustrates a method for augmenting an answer set on an online platform, in accordance with an embodiment of the present subject matter.

The figure depicts an embodiment of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “receiving,” “comparing,” “identifying,” “counting,” “alerting,” “augmenting,” and other forms thereof, are intended to be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any system and methods similar or equivalent to those described herein can be used in the practice or testing of embodiments of the present disclosure, the exemplary, system and methods are now described.

The disclosed embodiments are merely examples of the disclosure, which may be embodied in various forms. Various modifications to the embodiment will be readily apparent to those skilled in the art and the generic principles herein may be applied to other embodiments. However, one of ordinary skill in the art will readily recognize that the present disclosure is not intended to be limited to the embodiments described but is to be accorded the widest scope consistent with the principles and features described herein.

The present subject matter discloses a method and a system for augmenting an answer set on an online platform. The online platform is used to conduct an online test. A question is asked to plurality of candidates. The plurality of candidates may provide an answer to the question differently. A predefined answer is stored in the memory of the system. The system will compare the answer with the predefined answer. When the answer exactly matches with the predefined answer, the system assigns a score to a candidate. Generally, when the answer doesn't match with the predefined answer the system doesn't assign a score to the candidate. However, there might be some questions which may have more than one answers which may be correct but are not part of the predefined answer set. The main goal of the invention is to efficiently evaluate each answer submitted by the candidate. The system may automatically identify a deviation between the answer and the predefined answer. Further, the system counts number of occurrences of the answer which deviates from the predefined answer. The system then re-evaluates the answer when the number of occurrences of the answer exceeds a predefined threshold. Finally, a predefined answer set is augmented by adding the answer post validating the answer.

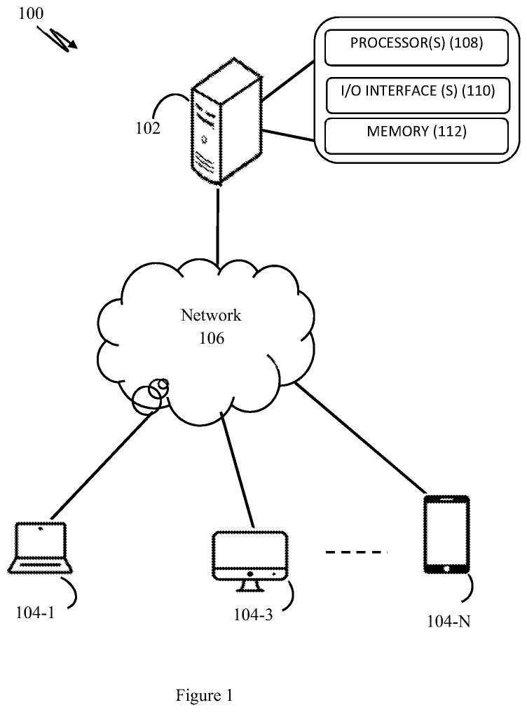

Referring now to FIG. 1, a network implementation 100 of a system 102 for augmenting an answer set on an online platform is disclosed. Initially, the system 102 receives an answer for a question. In an example, the software may be installed on a user device 104-1. It may be noted that the one or more users may access the system 102 through one or more user devices 104-2, 104-3 . . . 104-N, collectively referred to as user devices 104, hereinafter, or applications residing on the user devices 104. The system 102 receives the answer for a question from one or more user devices 104. Further, the system may also 102 receive a feedback from a user using the user devices 104.

Although the present disclosure is explained considering that the system 102 is implemented on a server, it may be understood that the system 102 may be implemented in a variety of computing systems, such as a laptop computer, a desktop computer, a notebook, a workstation, a virtual environment, a mainframe computer, a server, a network server, a cloud-based computing environment. It will be understood that the system 102 may be accessed by multiple users through one or more user devices 104-1, 104-2 . . . 104-N. In one implementation, the system 102 may comprise the cloud-based computing environment in which the user may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network, or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In one embodiment, the system 102 may include at least one processor 108, an input/output (I/O) interface 110, and a memory 112. The at least one processor 108 may be implemented as one or more microprocessors, microcomputers, microcontrollers, digital signal processors, Central Processing Units (CPUs), state machines, logic circuitries, and/or any devices that manipulate signals based on operational instructions. Among other capabilities, the at least one processor 108 is configured to fetch and execute computer-readable instructions stored in the memory 112.

The I/O interface 110 may include a variety of software and hardware interfaces, for example, a web interface, a graphical user interface, and the like. The I/O interface 110 may allow the system 102 to interact with the user directly or through the client devices 104. Further, the I/O interface 110 may enable the system 102 to communicate with other computing devices, such as web servers and external data servers (not shown). The I/O interface 110 can facilitate multiple communications within a wide variety of networks and protocol types, including wired networks, for example, LAN, cable, etc., and wireless networks, such as WLAN, cellular, or satellite. The I/O interface 110 may include one or more ports for connecting a number of devices to one another or to another server.

The memory 112 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, Solid State Disks (SSD), optical disks, and magnetic tapes. The memory 112 may include routines, programs, objects, components, data structures, etc., which perform particular tasks or implement particular abstract data types. The memory 112 may include programs or coded instructions that supplement applications and functions of the system 102. In one embodiment, the memory 112, amongst other things, serves as a repository for storing data processed, received, and generated by one or more of the programs or the coded instructions.

As there are various challenges observed in the existing art, the challenges necessitate the need to build the system 102 for augmenting an answer set on an online platform. At first, a user may use the user device 104 to access the system 102 via the I/O interface 110. The user may register the user devices 104 using the I/O interface 110 in order to use the system 102. In one aspect, the user may access the I/O interface 110 of the system 102. The detail functioning of the system 102 is described below with the help of figures.

The present subject matter describes the system 102 for augmenting an answer set on an online platform. The system 102 may receive an answer for a question. It may be noted that the answer is received from a plurality of candidates. Further, the question is at least one of a descriptive question, a program code, a fill in the blank question, a Multiple-Choice Question (MCQ), and a Multiple Answer Question (MAQ). In an embodiment, the descriptive question may be an essay.

Further to receiving the answer, the system 102 may compare the answer with a predefined answer. It may be noted that the predefined answer set is provided by at least an examiner or an online platform. In an embodiment, the online platform may comprise data repositories, open source data, internet, online education platform. In an embodiment, the system 102 may assign a score when the answer exactly matches with the predefined answer. In the embodiment, the system 102 may categorize the matched answer as “Exact Match.”

Consider an example, assuming 300 candidates are appearing for a test. Further, the system receives 300 answers from 300 candidates to a question. In the example, assuming 50 student's answer matches with the predefined answer. The system 102 may assign a score to 50 students whose answer matches with the predefined answer.

Further to comparing the answer, the system 102 may identify a deviation between the answer and the predefined answer based upon the comparison. It may be noted that the deviation is identified based upon vectorization, cosine similarity, Euclidean distance, and machine learning based text similarity techniques.

Further to identifying the deviation, the system 102 may count a number of occurrences of the answer. In one embodiment, the system may plot a graph of the count of the answer.

Further to counting, the system 102 may alert when the number of occurrences of the answer exceeds a predefined threshold. It may be noted that the alert may be sent to an examiner or a host of the online assessment test. Further, the predefined threshold may be set by the examiner or the online assessment platform.

Further to alerting, the examiner is prompted to validate the answer. If the examiner accepts the deviated answer as one of a possible answer to the question, the predefined answer set is augmented. Thus, the system 102 may augment the predefined answer set by using a supervised learning approach. It may be noted that the predefined answer set is provided by at least the examiner and the online assessment platform. Further, the predefined answer set is continuously augmented as the answer is added to the predefined answer set. Hence, the system is continuously under learning and training.

Consider an example, assuming 300 students are appearing for an online assessment test. A question is asked to the candidates—“What is the capital of India?” The predefined answer is “New Delhi.” Out of 300 students, 50 student's answer matches with the predefined answer. Hence, the number of occurrences of the answer deviated from the predefined answer is 250. In the example, 150 students answer “Delhi” as the capital of India. Further, 75 students answer “Delli” as the capital of India. Furthermore, 25 students answer “Mumbai” as the capital of India. It may be noted that the system understands that the number of occurrences of the answer “Delhi” and “Delli” is high. The system 102 utilizes Artificially Intelligent techniques to evaluate the answers. Thus, the system 102 starts considering that “Delhi” and “Delli” might be the correct answer.

The system 102 further alerts an examiner to validate the answers “Delhi” and “Delli” as the number of occurrences of the answer exceeds a predefined threshold of 50. Furthermore, the examiner evaluates the answers and augments the predefined answer set by adding the answers “Delhi” and “Delli”. Hence, the augmented predefined answer set comprises “New Delhi”, “Delhi” and “Delli” as the answer. Furthermore, the system 102 may retrospectively assign the score to the candidates who answered at least one of “New Delhi”, “Delhi” and “Delli”.

In one embodiment, the system 102 evaluates the answer automatically without any human intervention. The system 102 may validate the answer based on the internet and open source repositories. In the embodiment, the examiner may provide a set of websites for validating the answer and augmenting the predefined answer set accordingly.

Consider another example, a question is asked to a plurality of candidates. The question is “Write a code of factorial of a number”. The predefined answer to the question is already stored in the system. It may be noted that the candidate may write the code on an online assessment platform in any programming language. The main objective here is to check candidate's logic for writing the code. Assuming 150 students appeared for the test. The system receives an answer to the question. The system compares the answer with the predefined answer using Machine Learning, Natural Language Processing (NLP) and Text Similarity Techniques. Further, 50 student's answer matches with the predefined answer. Further, the system identifies the deviation between the answer and the predefined answer. Assuming, 80 students have written a code for factorial of a number using a recursion technique which is not present in the predefined answer set. The system alerts when the number of occurrences of the answer with the recursion technique exceeds a predefined threshold. Further, the system validates the answer with the recursion technique as the correct answer to the question. Finally, the system 102 augments a predefined answer set by adding the recursion technique post validating the answer.

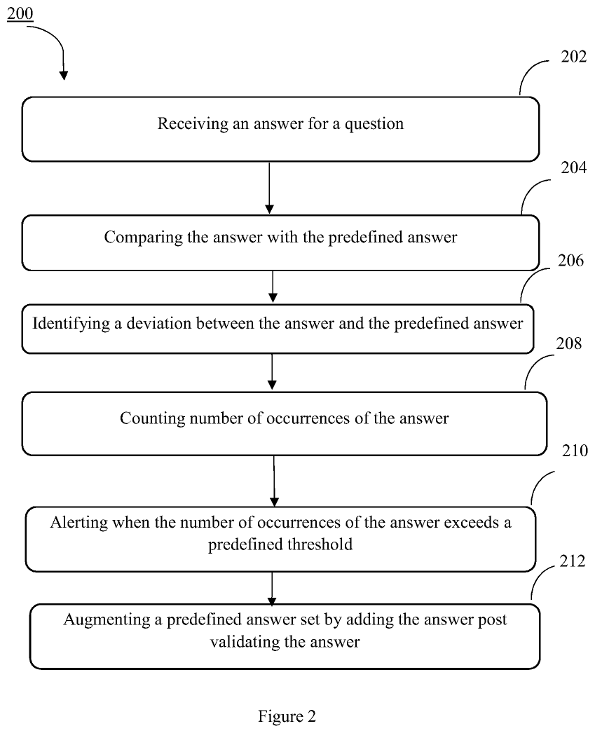

Referring now to FIG. 2, a method 200 for augmenting an answer set on an online platform is shown, in accordance with an embodiment of the present subject matter. The method 200 may be described in the general context of computer executable instructions. Generally, computer executable instructions can include routines, programs, objects, components, data structures, procedures, modules, functions, etc., that perform particular functions or implement particular abstract data types.

The order in which the method 200 is described is not intended to be construed as a limitation, and any number of the described method blocks can be combined in any order to implement the method 200 or alternate methods for augmenting an answer set on an online platform. Additionally, individual blocks may be deleted from the method 200 without departing from the scope of the subject matter described herein. Furthermore, the method 200 for augmenting an answer set on an online platform can be implemented in any suitable hardware, software, firmware, or combination thereof. However, for ease of explanation, in the embodiments described below, the method 200 may be considered to be implemented in the above-described system 102.

At block 202, an answer to a question may be received. The answer may be received from a plurality of candidates. In one implementation, the answer may be stored in the memory 112.

At block 204, the answer may be compared with a predefined answer. The predefined answer may be provided by an examiner or an online assessment platform. In one implementation, the predefined answer may be stored in the memory 112.

At block 206, a deviation may be identified between the answer and the predefined answer. The deviation is identified based upon at least one of vectorization, Euclidean distance, cosine similarity, and machine learning based text similarity techniques. In one implementation, the deviated answer may be stored in the memory 112.

At block 208, a number of occurrences of the answer may be counted. In one implementation, the number of occurrences may be stored in the memory 112.

At block 210, an alert may be generated when the number of occurrences of the answer exceeds a predefined threshold.

At block 212, a predefined answer set may be augmented by adding the answer post validating the answer. The validation may be performed by the examiner or an online assessment platform. In one implementation, the predefined answer set may be stored in the memory 112.

Exemplary embodiments discussed above may provide certain advantages. Though not required to practice aspects of the disclosure, these advantages may include those provided by the following features.

Some embodiments of the system and method enables the examiner examine the answers efficiently.

Some embodiments of the system and method uses Machine Learning, Natural Language Processing, and Deep Learning Techniques for evaluating an answer in real-time.

Some embodiments of the system and method is used to improve the predefined answer set.

Although implementations for methods and system for augmenting an answer set on an online platform have been described in language specific to structural features and/or methods, it is to be understood that the appended claims are not necessarily limited to the specific features or methods described. Rather, the specific features and methods are disclosed as examples of implementations for augmenting an answer set on an online platform.

1. A method for augmenting an answer set on an online platform, the method comprises:
receiving, by a processor, an answer to a question, wherein the answer is received from a plurality of candidates;
comparing, by the processor, the answer with a predefined answer using Machine Learning Techniques, Natural Language Processing (NLP), and Text Similarity Techniques;
identifying, by the processor, a deviated answer, wherein the deviated answer is the answer deviated from the predefined answer, and wherein deviation between the answer and the predefined answer is identified based upon the comparison, and wherein the deviation is identified based upon vectorization, cosine similarity, Euclidean distance, and machine learning based text similarity techniques;
counting, by the processor, a number of occurrences of the deviated answer;
alerting, by the processor, when the number of occurrences of the deviated answer exceeds a predefined threshold; and
augmenting, by the processor, a predefined answer set by adding the deviated answer post validating based on the alert, wherein the predefined answer set is augmented by using a supervised learning approach.

2. (canceled)

3. The method as claimed in claim 1, wherein the predefined answer set is provided by at least an examiner or an online platform.

4. The method as claimed in claim 1, wherein the question is one of a descriptive question, a program code, a fill in the blank question, a Multiple-Choice Question (MCQ), and a Multiple Answer Question.

5. The method as claimed in claim 1, further comprising assigning a confidence score to the answer in order to validate the answer.

6. A system for augmenting an answer set on an online platform, the system comprising:
a memory; and
a processor coupled to the memory, wherein the processor is configured for:
receiving an answer to a question, wherein the answer is received from a plurality of candidates;
comparing the answer with a predefined answer using Machine Learning Techniques, Natural Language Processing (NLP), and Text Similarity Techniques;
identifying a deviated answer, wherein the deviated answer is the answer deviated from the predefined answer, and wherein deviation between the answer and the predefined answer is identified based upon the comparison, and wherein the deviation is identified based upon vectorization, cosine similarity, Euclidean distance, and machine learning based text similarity techniques;
counting a number of occurrences of the deviated answer;
alerting when the number of occurrences of the deviated answer exceeds a predefined threshold; and
augmenting, based on the alert, a predefined answer set by adding the deviated answer post validating, wherein the predefined answer set is augmented by using a supervised learning approach.

7. (canceled)

8. The system as claimed in claim 6, wherein the predefined answer set is provided by at least an examiner or an online platform.

9. The system as claimed in claim 6, wherein the question is one of a descriptive question, a program code, a fill in the blank question, a Multiple-Choice Question (MCQ), and a Multiple Answer Question.

10. The system as claimed in claim 6, wherein the predefined answer set is provided by at least an examiner or an online platform

11. A non-transitory computer program product having embodied thereon a computer program for augmenting an answer set on an online platform, the computer program product storing instructions, the instructions for:
receiving an answer to a question, wherein the answer is received from a plurality of candidates;
comparing the answer with a predefined answer using Machine Learning Techniques, Natural Language Processing (NLP), and Text Similarity Techniques;
identifying a deviated answer, wherein the deviated answer is the answer deviated from the predefined answer, and wherein deviation between the answer and the predefined answer is identified based upon the comparison, and wherein the deviation is identified based upon vectorization, cosine similarity, Euclidean distance, and machine learning based text similarity techniques;
counting a number of occurrences of the deviated answer;
alerting when the number of occurrences of the deviated answer exceeds a predefined threshold; and
augmenting, based on the alert, a predefined answer set by adding the answer post validating, wherein the predefined answer set is augmented by using a supervised learning approach.

12. The method as claimed in claim 1, wherein the question is a program code.

13. The system as claimed in claim 6, wherein the question is a program code.
